(19) United States
(12) Patent Application Publication
(10) Pub. No.: US 2013/0059211 A1
(43) Pub. Date: Mar. 7, 2013

(54) CATHODIC ELECTRODE AND ELECTROCHEMICAL CELL FOR DYNAMIC APPLICATIONS

(71) Applicants: Tim Schaefer, Harztor (DE); Andreas Gutsch, Luedinghausen (DE)

(72) Inventors: Tim Schaefer, Harztor (DE); Andreas Gutsch, Luedinghausen (DE)

(73) Assignee: LI-TEC BATTERY GMBH, Kamenz (DE)

(21) Appl. No.: 13/582,780

(22) PCT Filed: Feb. 22, 2011
(86) PCT No.: PCT/EP11/00838

§ 371 Date: Nov. 13, 2012

(30) Foreign Application Priority Data
Mar. 15, 2010 (DE) 10 2010 011 413.8

(51) Int. Cl. H01M 4/525; H01M 2/16; H01M 16/00

(52) U.S. Cl. 429/400; 429/50; 429/144

(57) ABSTRACT

The present invention relates to a cathodic electrode for an electrochemical cell, comprising at least one carrier having at least one active material applied or deposited thereon, wherein the active material either comprises: (1) at least one lithium polyanion compound; or (2) a mixture made of a lithium/nickel/manganese/cobalt mixed oxide (NMC), which is not present in a Spinell structure, and a lithium manganese oxide (LMO) in a Spinell structure; or (3) a mixture of (1) and (2), wherein the carrier comprises a metallic material, in particular aluminum, and has a thickness of 15 μm to 45 μm, in particular an electrochemical cell having a high energy density. The present active material allows not only the energy density, but also the stability of the cell to be optimized. Furthermore, material costs and availability of materials are taken into consideration.

The content of priority application DE 10 2010 011 413.8 as filed on Mar. 15, 2010 is included, in its entirety, in the present disclosure by means of incorporation by reference.

The present invention relates to a cathodic electrode for an electrochemical cell, in particular for an electrochemical cell having a high energy density and power density. In addition to the energy density, also the stability of the cell is optimized by means of the present active material. Furthermore, material costs and availability of materials for the electrode are taken into account.

In accordance with the present invention, the cathodic electrode (cathode electrode) comprises at least one carrier having at least one active material applied or deposited thereon, wherein the active material either comprises:
(1) at least one lithium polyanion compound, or
(2) a mixture of a lithium-nickel-manganese-cobalt mixed oxide (NMC) which is not present in a spinel structure, and a lithium-manganese oxide (LMO) in a spinel structure, or
(3) a mixture of (1) and (2),
   wherein the carrier comprises a metallic material, in particular aluminum, and the carrier has a thickness of from 15 μm to 45 μm.

The low thickness of the carrier (collector material) of the electrode is particularly relevant, namely in particular with respect to the durability and the operating mode of the electrodes according to the invention for ionic cells. The carriers/collectors of the electrodes contribute to its stability, to the possibility to apply a thin coating and to its cooling.

Preferably, the carrier is formed as a collector foil, as a sheet or as a thin sheet.

Furthermore, the present invention relates to an electrochemical cell, in particular to an electrochemical cell having a high energy density and power density, which comprises said cathodic electrode, as well as at least one anodic electrode, as well as at least one separator, which is at least partially located on or between cathodic and anodic electrode.

Preferably, the anodic electrode comprises at least one carrier, which preferably comprises copper or a carbon composite, wherein said carrier has a thickness of from 15 μm to 45 μm.

Preferably, the carrier is formed as a collector foil.

Said cathodic electrode, respectively said electrochemical cell, has a preferred application in batteries, in particular in batteries having a high energy density and/or high power density (so-called “high power batteries”, respectively “high energy batteries”).

In accordance with the present invention, applications of the cathodic electrode, respectively of the electrochemical cell, in lithium ion cells and in lithium ion batteries are particularly preferred.

Further preferably, said lithium ion cells and lithium ion batteries are to be applied in electrical tools and for powering vehicles, in particular for completely electrically driven vehicles as well as for predominantly electrically driven vehicles or for vehicles in in the so-called “hybrid”-operation, thus combined with a combustion engine.

Also any application of such batteries combined with fuel cells as well as in stationary operation is included.

In the field of the battery technology, in particular with respect to lithium ion batteries, it is generally accepted that the selection of the cathodic electrode materials for the respectively intended application is of a particular importance. Thus, for example, active materials for application in portable electric devices (communication electronics) are known, in particular lithium-cobalt oxide (for example LiCoO₂) or lithium-(nickel)-cobalt-aluminum oxide (NCA). These active materials, which are already successfully used commercially, however, are, based on costs (cobalt is a comparatively expensive transition metal), not necessarily suitable to the same extent for applications in electrical vehicles or vehicles having a hybrid drive, since for these uses, much higher amounts of active materials are needed, and thus the price/the availability of these active materials plays a larger role. Also with respect to capacities, some of these conventional materials are limited.

An active material for cathodic electrodes, which may be, in principle, used for electrochemical cells and batteries, which may be used in electrical tools, electrically driven vehicles or vehicles having hybrid drive, are lithium mixed oxides with nickel, manganese and cobalt (lithium-nickel-manganese-cobalt mixed oxides, “NMC”). For reliability and cost reasons, lithium-nickel-manganese-cobalt mixed oxides are preferred compared to lithium-cobalt oxides.

With respect to nickel-manganese-cobalt-mixed oxides of lithium (in some references also termed as “NCM”), which are suitable as the active material for cathodic electrodes, it is discussed as a possible drawback that cathodic electrodes based on said materials, as the case may be, may have aging symptoms in long-term operation. With respect to an electrochemical cell comprising cathodic and anodic electrodes and separator, the reduced stability of NMC as cathodic electrode material may result in a separator with increased thickness.

For cost reasons, as well as with respect to the availability of active materials, also in the future, in particular due to highly increased demand, also lithium polyanion compounds, for example LiFePO₄, are suitable as active materials for cathodic electrodes, which may be used for electrochemical cells and batteries also in the high power range.

In light of the prior art, one object of the present invention may be seen in providing an electrochemical cell, which is reliable and which provides a comparatively high energy density and/or power density and takes into account cost aspects as well as availability of the active materials.

A preferred object of the present invention consists in providing an electrochemical cell, which, having improved durability and reliability, has reduced dimensions and thus provides an improved energy density and/or power density.

According to invention, the above-mentioned objects and other objects are solved by providing a cathodic electrode for an electrochemical cell, comprising at least one carrier having at least one active material applied or deposited thereon, wherein the active material either comprises
(1) at least one lithium polyanion compound or
(2) a mixture of a lithium-nickel-manganese-cobalt mixed oxide (NMC), which is not present in a spinel structure, with a lithium-manganese oxide (LMO) in a spinel structure, or
(3) a mixture of (1) and (2),
   wherein the carrier comprises a metallic material, in particular aluminum, and the carrier has a thickness of 15 μm to 45 μm.

According to invention, these objects are also solved by an electrochemical cell, comprising:
a cathodic electrode comprising at least one carrier having at least one active material applied or deposited thereon, wherein the active material either comprises
   (1) at least one lithium polyanion compound, or
   (2) at least a mixture of a lithium-nickel-manganese-cobalt mixed oxide (NMC), which is not present in a spinel structure, with a lithium-manganese oxide (LMO) in a spinel structure, or
   (3) a mixture of (1) and (2)
wherein the carrier comprises a metallic material, in particular aluminum, and the carrier has a thickness of 15 μm to 45 μm;
an anodic electrode, and
a separator, which is at least partially located on or between a cathodic and/or an anodic electrode.

Preferably, the anodic electrode comprises at least one carrier, which preferably comprises copper or a carbon composite, wherein the said carrier has a thickness of from 15 μm to 45 μm.

The carrier in the above-mentioned embodiments preferably is formed as collector foil.

It is further preferred that said separator comprises at least on porous ceramic material, which preferably is present in a layer, which is applied on an organic carrier material, wherein said organic carrier material further preferably comprises a non-woven polymer.

Said cathodic electrode, respectively said electrochemical cell, have a preferred application in batteries, which preferably are used in electrical tools and electrically driven vehicles, including vehicles having hybrid drive or in combination with fuel cells. Thereby, these batteries should have a high energy density and/or power density.

The term “cathodic electrode” characterizes an electrode, which, when connected to a load (“discharge”), for example during operation of an electric engine, receives electrons. Thus, in this case, the cathodic electrode is the “positive electrode”.

An “active material” of cathodic or anodic electrode in the meaning of the present invention is a material, which may intercalate lithium in ionic form or metallic form or in any intermediate form, in particular in a lattice structure (“intercalation”). Thus, the active material participates “actively” in the electrochemical reactions, which occur during charge and discharge (contrary to other possible components of the electrode such as binder, stabilizer or carrier).

In the meaning of the present invention, the cathodic electrode comprises at least one active material, wherein the active material either comprises
(1) at least one lithium polyanion compound, or
(2) at least a mixture of a lithium-nickel-manganese-cobalt mixed oxide (NMC), which is not present in a spinel structure, with a lithium-manganese oxide (LMO) in a spinel structure, or
(3) a mixture of (1) and (2).

Therein, the lithium polyanion compound preferably is selected from the group comprising:

| Group | Sub-group | Examples |
|---|---|---|
| Na superion | M³⁺(X⁶⁺O₄)₃ | monoclinic Fe₂(SO₄)₃, |
| conductor | | rhombohedral |
| | | Fe₂(SO₄)₃, Fe₂(MoO₄)₃ |
| | LiM³⁺₂(X⁶⁺O₄)₂(X⁵⁺O₄) | LiFe₂(SO₄)₂(PO₄) |
| | LiM³⁺₂(X⁵⁺O₄)₃ | monoclinic Li₃Fe₂(PO₄)₃, |
| | | rhombohedral Li₃Fe₂(PO₄)₃, |
| | | monoclinic Li₃V₂(PO₄)₃, |
| | | rhombohedral |
| | | Li₃V₂(PO₄)₃, Li₃Fe₂(AsO₄)₃ |
| | LiM⁴⁺₂(X⁵⁺O₄)₃ | Li₃Ti₂(PO₄)₃ |
| | Li₂M⁴⁺M³⁺(X⁵⁺O₄)₃ | Li₂TiFe(PO₄)₃, Li₂TiCr(PO₄)₃, |
| | Li₂M⁵⁺M³⁺(X⁵⁺O₄)₃ | LiNbFe(PO₄)₃ |
| | M⁵⁺M⁴⁺(X⁵⁺O₄)₃ | NbTi(PO₄)₃ |
| Pyrophosphate | | Fe₄(P₂O₇)₃, LiFeP₂O₇, TiP₂O₇, |
| | | LiVP₂O₇, MoP₂O₇, Mo₂P₂O₇, |
| Olivines | | LiFePO₄, Li₂FeSiO₄ |
| Amorphous FePO₄ | | FePO₄•nH₂O, FePO₄ |
| MOXO₄ | M⁵⁺OX⁵⁺O₄ | α-MoOPO₄, β-VOPO₄, γ-VOPO₄, |
| | | 30δ-VOPO₄, ε-VOPO₄, βVOAsO₄ |
| | LiM⁴⁺OX⁵⁺O₄ | α-LiVOPO₄ |
| | M⁴⁺OX⁶⁺O₄ | β-VOSO₄30 |
| | Li₂M⁴⁺OX⁴⁺O₄ | Li₂VOSiO₄ |
| Brannerite | | LiVMoO₆ |
| Borates | | Fe₃BO₆, FeBO₃, VBO₃, TiBO₃ |

Thereby, “X” is a heteroatom such as P, N, S, B, C or Si and “XO” is a (hetero-) polyanion; “M” is a transition metal ion. Adjacent “XO” units are preferably connected via their respective corners.

Compounds of formula LiMPO₄ are particularly preferred, wherein “M” is at least one transition metal cation of the first row of the periodic table of the elements. The transition metal cation is preferably selected from the group consisting of Mn, Fe, Ni, or Ti, or a combination of these elements. The compound preferably has an olivine structure, preferably superordinate olivine.

The above-mentioned polyanionic compounds are thus particularly preferred, since they are characterized by favorable costs and good availability, in particular also compared to active materials, which contain cobalt. These criteria (costs/availability) appear not to be relevant for battery applications in the entertainment electronics, respectively communication electrons (mobiles, laptops), however the relevant for electrically driven vehicles, which have a much higher demand for active materials.

In one embodiment of the present invention, at least one polyanion is used as essential active material for the cathodic electrode, i.e. at least 50%, preferably at least 80%, further preferred at least 90% of the active material of the cathode comprise the at least one polyanionic material (mole %, respectively).

In a preferred embodiment, the active material of the cathodic electrode comprises at least one lithium polyanion compound combined with at least one mixture of (i) a lithium-nickel-manganese-cobalt mixed oxide (NMC) which is not present in a spinel structure, with (ii) a lithium-manganese oxide (LMO) in a spinel structure. Such a mixture improves the stability of the respective electrochemical cell, and at the same time allows for a thinner coating of the active material on the substrate. Low layer thicknesses decrease the impedance (“internal resistance”) of the cell, which reflects positively in all applications of the cell, however, in particular in the “high power” (high-performance) applications.

Thereby, in such a mixture, preferably at least 20 mole %, preferably at least 40 mole %, further preferably at least 60 mole % of active material are present in form of at least one polyanion. With respect to the ratio of lithium-nickel-manganese-cobalt mixed oxide to lithium-manganese oxide, the preferred ranges apply as defined below.

According to another embodiment, the active material for the cathodic electrode comprises at least one mixture of a lithium-nickel-manganese-cobalt mixed oxide (NMC), which is not present in a spinel structure, with a lithium-manganese oxide (LMO) in a spinel structure. Therein, this mixture preferably, is the essential active material for the cathodic electrode, i.e. at least 80%, preferably at least 90% of the active material of the cathode comprise the at least one mixture of a lithium-nickel-manganese-cobalt-mixed oxide (NMC), which is not present in a spinel structure, with a lithium-manganese oxide (LMO) in a spinel structure.

It is preferred for all embodiments in which such a lithium-nickel-manganese-cobalt mixed oxide/lithium-manganese oxide mixture is present (i.e. alone or combined with polyanionic compounds), that the active material comprises at least 30 mole %, preferably at least 50 mole % NMC, as well as, simultaneously, at least 10 mole %, preferably at least 30 mole % LMO, based on the total mole number of the active material of the cathodic electrode, respectively (thus not based on the cathodic electrode taken as a whole, which, in addition to the active material, may comprise additives for electrical conductivity, binders, stabilizers, etc.).

It is particularly preferred that the amount of the lithium-manganese oxide in the active material ranges from 5 to 25 mole %.

It is preferred that in combination, NMC and LMO are present in an amount of 60 mole % of the active material, further preferred at least 70 mole %, further preferred at least 80 mole %, further preferred at least 90 mole %, based on the total amount of moles of the active material of the cathodic electrode, respectively (thus not based on the cathodic electrode taken as a whole, which, in addition to the active material, may comprise additives for the electrical conductivity, binders, stabilizers, etc.).

For all the above-mentioned embodiments relating to the active material (i.e. polyanions/polyanions plus lithium-nickel-manganese-cobalt mixed oxide with lithium-manganese oxide/lithium-nickel-manganese-cobalt mixed oxide with lithium-manganese oxide alone), it is preferred that the material, which is applied onto the carrier, essentially is an active material, i.e. 80 to 95 wt.-% of the material, which is applied on the carrier of the cathodic electrode is said active material, further preferably 86 to 93 wt.-%, based on the total weight of the material, respectively (thus based on the cathodic electrode taken as a whole, without carrier, which, in addition to the active material may comprise additives for electric conductivity, binders, stabilizers, etc.)

With respect to the weight ratio of NMC as active material to LMO as active material, it is preferred that this ratio ranges from 9 (NMC):1 (LMO) to 3 (NMC):7 (LMO), wherein 7 (NMC):3 (LMO) to 3 (NMC):7 (LMO) is preferred, and wherein 6 (NMC):4 (LMO) to 4 (NMC):6 (LMO) is further preferred.

A mixture of lithium-nickel-manganese-cobalt mixed oxide (NMC) with at least one lithium-manganese oxide (LMO) results in an increased stability, in particular in an improved durability, of the cathodic electrode. Without being bound by theory, it is believed that these improvements are attributed to an increased manganese amount compared to pure NMC. Thereby, in a mixture, the high energy density and the further advantages of the lithium-nickel-manganese-cobalt mixed oxide (NMC) compared to lithium-manganese oxides (LMO) are maintained, to the largest extent possible. In experiments, it has been shown that the above-mentioned mixtures of lithium-nickel-manganese-cobalt mixed oxides with lithium-manganese oxide (with or without admixture of the preferred further component of the at least one lithium polyanion compound) show almost no capacity loss after 250 charge and discharge cycles or in the temperature aging test. The 80% capacity limit relating to the original capacity is achieved after only 25,000 full cycles.

In the temperature aging test and when fully loaded, for the preferred mixtures according to the invention, a high durability above average was achieved compared to “pure” NMC, which indicates a durability of more than 12 years. Thereby, all in all, also the temperature stability of the cell was improved.

A combination of these materials with the above-mentioned portions of polyanion-active materials is particularly preferred, since hereby also the costs are minimized without significantly limiting the performance of the battery.

The increased thermal stability of the cathodic electrode, as discussed above, therefore allows to make the separator layer in the electrochemical cell, having an intrinsic resistance, thinner (see for this the embodiments mentioned below relating to the electrochemical cell having cathodic electrode, separator and anodic electrode), whereby the energy density and power density of the cell taken as a whole is increased.

Mixed oxides comprising cobalt, manganese and nickel (“NMC”), in particular one-phase lithium-nickel-manganese-cobalt mixed oxides as such are known as possible active materials for electrochemical cells from the prior art (see for example WO 2005/056480 as well as the basic scientific publication of Ohzuku from the year 2001 [T. Ohzuku et al., Chem. Letters 30 2001, pages 642 to 643]).

In principle, there are no restrictions concerning the composition (stoichiometry) of the lithium-nickel-manganese-cobalt mixed oxide, except that this oxide has to contain, besides lithium, at least 5 mole %, preferably at least 15 mole %, preferably at least 30 mole % of nickel, manganese and cobalt, respectively, based on the total molar number of transition metals in the lithium-nickel-manganese-cobalt mixed oxide, respectively. The lithium-nickel-manganese-cobalt mixed oxide may be doped with any other metal, in particular transition metals, as long as it is ensured that the above-mentioned molar minimum amounts of Ni, Mn, and Co are present.

Therein, a lithium-nickel-manganese-cobalt mixed oxide of the following stoichiometry is particularly preferred: Li[Co_{1/3}Mn_{1/3}Ni_{1/3}]O₂, wherein the amount of Li, Co, Mn, Ni and O may vary by +/−5%, respectively.

A slightly “overlithiated” stoichiometry of Li₁₊ₓ[Co_{1/3}Mn_{1/3}Ni_{1/3}]O₂ with x in the range of from 0.01 to 0.10 is particularly preferred since by means of such “overlithiation” better cycle properties are achieved compared to a 1:1 stoichiometry.

In accordance with the present invention, these lithium-nickel-manganese-cobalt mixed oxides are not present in a spinel structure. Rather, preferably, they are present in a layer structure, for example in an “O3-structure”. Further preferably, these lithium-nickel-manganese-cobalt mixed oxides of the present invention are not subject to a noteworthy phase transfer into another structure (i.e. not to an extent of more than 5%) also during discharge and charge operations, in particular no noteworthy transfer to a spinel structure takes place.

Compared to this, lithium-manganese oxides (“LMO”) are present in a spinel structure. Lithium-manganese oxide in spinel structure, and in the meaning of the present invention, comprises, as transition metal, at least 50 mole %, preferably at least 70 mole %, further preferably at least 90 mole % of manganese, based on the total molar number of the transition metals, which are present in the oxide, respectively. A preferred stoichiometry of the lithium-manganese oxide is Li₁₊ₓMn_{2-y}M_{y}O₄, wherein M is at least one metal, in particular at least one transition metal, and −0.5 (preferably −0.1)≦x≦0.5 (preferably 0.2), 0≦y≦0.5.

A “spinel structure” is known to the person skilled in the art as a widely spread crystal structure for compounds of the type AB₂X₄, which is termed according to its main representative, the mineral “spinel” (magnesium aluminate, MgAl₂O₄). The structure consists of a cubic close packing of the chalkogenide (here: oxygen) ions, whose open spaces in the tetrahedron and octahedron sites are (partially) occupied by the metal ions. Spinels as cathodic materials for lithium ion cells are exemplarily described in chapter 12 of “Lithium Batteries”, edited by Nazri/Pistoia (ISBN: 978-1-4020-7628-2).

Pure lithium-manganese oxide may exemplarily have the stoichiometry LiMn₂O₄. However, lithium-manganese oxides as used within the scope of the present invention, are preferably modified and/or stabilized, since pure LiMn₂O₄ has the drawback that Mn ions may be released from the spinel structure under certain circumstances. In principle, there are no further restrictions how this stabilization of the lithium-manganese oxide may be effected as long as the lithium-manganese oxide may be maintained stable over the desired durability under the operating conditions of a lithium ion cell. With respect to known stabilization methods, exemplary reference is made to WO 2009/011157, U.S. Pat. No. 6,558,844, U.S. Pat. No. 6,183,718 or EP 816 292. These describe the use of stabilized lithium-manganese oxide in a spinel structure as the exclusive active material for cathodic electrodes in lithium ion batteries. Particularly preferred stabilization methods comprise doping as well as coating.

There are no restrictions with respect to the manner in which the active materials (lithium-polyanion compound, NMC and LMO) are mixed. Physical mixtures (for example by mixing powders or particles, in particular with energy input) or chemical mixtures (for example by means of combined deposition from the gas phase or an aqueous phase, for example dispersion) are preferred, wherein it is further preferred that the active materials are in a homogeneous mixture as the result of a mixing process. Therefore, the components are no longer observable as separated phases without physical tools.

Preferred mixtures are present as homogeneous powders or pastes or dispersions. In a preferred embodiment, the mixture is produced by way of paste extrusion continuously, optionally without a previous mixing and drying phase, and is applied and densified to the electrode.

For extrusion, as a flow enhancing additive, one of the components of the electrolyte may be used, however, also a mixture, for example ethyl carbonate (EC)/ethyl methyl carbonate (EMC) in a ratio around 3:1 (+/−20%).

Therein, processing in mixers is preferred, which are run or may be charged in an inert manner and preferably free from water.

According to the present invention, the manufacture of the coated electrodes or of the cell laminate by means of paste extrusion is preferred. In a paste extruder (for example “Common Tec”), which preferably works on the principle of piston string extrusion (“Kolbenstrangextrusion”), the active materials are fed, applied and then pressed through a nozzle. The extrudate, which may still contain lubricants, is freed from the lubricant in a drying zone and is subsequently sintered and/or calendared. Thereby, abrasion is minimized, which contributes to an increased durability of the aggregates and the cells. Energy is saved since extrusion may be performed at room temperature and complex, controlled homogeneous heating may be omitted. Also, unpleasant odor caused by lubricant vapors at the extruder is minimized.

It is preferred that in the step of paste extrusion via microinjection, further materials such as radical scavengers or ionic liquids are extruded, which effect a prolonged durability of the cells, for example by means of injection across an area/mass of extruded ingredients regarding the amount of the described additives or stabilizers, respectively, of additives such as vinylene carbonate or fire retardants such as “firesorb”, or also nano-sized structure material in microcapsules, whose encapsulation may consist of polymeric materials, which, in particular, may only diffuse out from these capsules when the temperature is raised, and which wet the electrode or ionically seal the electrode. Hereby, micro short-circuits and/or local “hot spots” are prevented within the cells, and, overall, the reliability of the cell is further increased.

In a further exemplary approach with the objective to create a cell for a “10C”-charge and “20C”-discharge operation, ribbons for the carrier material comprising copper or aluminum were chosen having a thickness of 30 or 20 μm, which simultaneously cool the cell and the electrode material in an improved manner, which thus are accordingly capable of conducting current. On the carrier/substrate, preferably electrodes in a thickness range (total thickness: carrier+active material) cathode 50 μm to 125 μm and anode 10 μm to 80 μm are produced after calendaring. The electrodes in the upper range of the mentioned thicknesses are processed to “high energy” cells, and conversely the thinner electrodes are perused to “high power” cells.

The above-mentioned stabilizers and additives for the electric conductivity are preferably injected in an amount of maximal 3%, respectively.

With regard to the mixtures, it is preferred that the active material and thereby in particular the lithium-nickel-manganese-cobalt mixed oxide and the lithium-manganese oxide are present in particulate form, respectively, preferably as particles having an average diameter of from 1 μm to 50 μm, preferred from 2 μm to 40 μm, further preferred from 4 μm to 20 μm. Thereby, the particles may also be secondary particles, which are built up from primary particles. Then, the above-mentioned average diameters relate to the secondary particles.

A homogeneous and intense mixing of the phases, in particular of the phases in particulate form, contributes to the aging resistance of the lithium-nickel-manganese-cobalt mixed oxide, which is particularly favorably influenced in this mixture.

Other types of “mixture”, for example the alternating application of layers on a carrier, or the coating of particles, are also possible.

In accordance with the present invention, the active material is “applied” on a carrier. There are no restrictions with respect to this “applying” of the active material onto the carrier. The active material can be applied as paste or as powder, or may be deposited from the gas phase or a liquid phase, for example as a dispersion.

Preferably, the coating of the carrier with the active masses is carried out in a manner avoiding material stress, which might result in an impairment of the structures such as breakages, and which might result in an early aging of the electrode or of the element.

Therein, an extrusion method is preferred. Preferably, the active material is applied directly as paste or dispersion onto the cathodic electrode. By means of co-extrusion with other components of the electrochemical cell, in particular anodic electrode and separator, a layered or a laminate composite is created (see discussion with respect to extrudates and laminates below). Such methods are, for example, disclosed in EP 1 783 852. The terms “paste” and “dispersion” are used synonymously.

A “layered” electrode stack thereby is not permanently sticked together, however, the layers (cathode-separator-anode, etc.) are merely laid one upon the other and, as the case may be, are pressed. In a “laminate”, additionally an adhesive and/or a heat treatment is carried out such that the stack is durably laminated (“sticked together”), and thus is kept together independently from a possible pressing (for example achieved by applying vacuum at a vacuum-sealed casing around the electrode stack).

Within the scope of the present invention, it is also possible that the electrodes and the separator are wound, preferably in a flat pack winding.

Preferably, the active material is not applied onto the carrier as such, but in combination with other non-active components (i.e. components, which do not intercalate lithium).

Therein, it is preferred that, besides the at least one active material, at least one binder or one binder system is present, thus is part of the cathodic electrode (without carrier). This binder may be or may comprise SBR, PVDF, a PVDF-homo or copolymer (such as, for example, Kynar 2801 or Kynar 761).

The cathodic electrode optionally comprises a stabilizer, for example Aerosil or Sipernat. It is preferred that these stabilizers are present in a weight ratio of up to 5 wt.-%, preferably up to 3 wt.-%, based on the total amount of the mass, which has been applied to the carrier of the cathodic electrode, respectively.

It is preferred that this stabilizer comprises the separator described below, i.e. a separator comprising at least one porous ceramic material, in particular “Separion” as described below, as a powder admixture, preferably in a weight ratio of from 1 wt.-% to 5 wt.-%, further preferred of from 1 wt.-% to 2.5 wt.-%, based on the total weight of the mass, which is applied onto the carrier of the cathodic electrode, respectively. In particular with respect to an electrochemical cell having a separator layer comprising at least one porous ceramic material, as described below, this results in particularly stable and reliable cells.

It is further preferred that besides the at least one active material (as well as optionally to the at least one binder or binder system and/or the at least one stabilizer) at least one additive for the electrical conductivity is present, thus is part of the cathodic electrode (without carrier). Such additives for the electrical conductivity, for example, comprise conductive carbon black (Enasco) or graphite (KS 6), preferably in a weight ratio of from 1 wt.-% to 6 wt.-%, further preferably from 1 wt.-% to 3 wt.-%, based on the total weight of the mass, which is applied onto the carrier of the cathodic electrode, respectively. Thereby, also structured materials, in particular structured materials in the nanometer range or conductive carbon “nanotubes” may be inserted, such as Bayer “Baytubes®”.

The above defined active materials for the electrodes, in particular for the cathodic electrodes, are present on a carrier. In accordance with the present invention, there are no restrictions with regard to the carrier or the carrier material except that this carrier or this carrier material must be suitable to support said at least one active material, in particular the at least one active material of the cathodic electrode, as well as that the carrier has a thickness of 15 μm to 45 μm, thus must comparatively be relatively thinly dimensioned. Thereby, the carrier is preferably formed as collector foil.

Furthermore, said carrier should substantially or at least predominantly be inert as far as possible during the operation of the cell, respectively the battery, compared to the active material, thus particularly during charge and discharge operation. The carrier may be homogeneous or may comprise a layer structure (layer composite) or may be a composite material or may comprise a composite material.

Preferably, the carrier also contributes to the discharge and conduction of electrodes. Thus, the carrier material preferably is at least partially electrically conductive, preferably electrically conductive. The carrier material comprises, in this embodiment, preferably aluminum or copper or consists of aluminum or copper. Thereby, the carrier preferably is connected to at least one electrical conductor.

The carrier may be coated or may not be coated and may be a composite material.

In a further embodiment of the present invention, the above described cathodic electrode is used in an electrochemical cell, wherein this electrochemical cell then comprises:
a cathodic electrode comprising at least one carrier having at least one active material applied or deposited thereon, wherein the active material either comprises
   (1) at least one lithium polyanion compound, or
   (2) at least a mixture of a lithium-nickel-manganese-cobalt mixed oxide (NMC), which is not present in a spinel structure, with a lithium-manganese oxide (LMO) in a spinel structure, or
   (3) a mixture of (1) and (2)
wherein the carrier comprises a metallic material, in particular aluminum, and the carrier has a thickness of from 15 μm to 45 μm;
an anodic electrode, and
a separator, which at least partially is located on or between a cathodic and/or an anodic electrode.

With respect to the cathodic electrode, all embodiments disclosed above for the said electrochemical cell are preferred.

The term “anodic electrode” characterizes the electrode, which, when connected to a load (“discharge”), such as an electric motor, releases electrons. Thus, in this case, the anodic electrode is the “negative electrode”.

With respect to the anodic electrode, in principle, there are no restrictions except that this electrode must, in principle, ensure the intercalation and release of lithium ions. The anodic electrode preferably comprises carbon and/or lithium titanate, further preferably coated graphite.

In a particular preferred embodiment, an anodic electrode is used in the electrochemical cell, which comprises coated graphite. Therein, it is particularly preferred that the anodic electrode comprises conventional graphite or so-called “soft” carbon (“soft carbon”), which is coated with a harder carbon, in particular with “hard carbon”. Thereby, the harder carbon/hard carbon has a hardness of ≧1,000 N/mm², preferably ≧5,000 N/mm².

The “conventional” graphite may be natural graphite such as UFG8 form Kropfmühl. Optionally, the C-fiber amount is up to 38%.

Preferably, the amount of “hard carbon” relative to “hard carbon”+“soft carbon” is maximal 15%.

An anodic electrode comprising conventional graphite (“soft carbon”, natural graphite), which is coated with “hard carbon”, particularly increases the stability of the electrochemical cell due to a synergistic effect with the cathodic electrode.

Preferably, the electrodes as well as the separator are present in layers in the form of foils or layers. This means that the electrodes as well as the separator are built up in form of a layer or in form of layers of the respective materials or substances. In the electrochemical cell, these layers may be laid one upon the other or may be laminated or may be wound.

It is preferred in accordance with the present invention, that the layers are laid one upon the other without laminating them.

In the electrochemical cell according to the invention, respectively batteries, the separators used therein, which separate a cathodic electrode from an anodic electrode, are formed such that they ensure an easy passage of charge carriers.

The separator is conductive for ions and preferably has a porous structure. In case of the electrochemical cell according to the invention, which works with lithium ions, the separator allows the passage of lithium ions through the separator.

It is preferred that the separator comprises at least one inorganic material, preferably at least one ceramic material. Therein it is preferred that said separator comprises at least one porous ceramic material, preferably in a layer, which is applied onto an organic carrier material.

In principle, a separator of this type is known from WO 99/62620, respectively may be produced according to methods, which are disclosed therein. Such a separator is commercially available under the trademark Separion® of the company Evonik.

Preferably, the ceramic material for the separator is selected from the group of the oxides, phosphates, sulfates, titanates, silicates, aluminosilicates, borates of at least one metal ion.

Further preferably, oxides of magnesium, calcium, aluminum, silicon, zirconium and titanium are used herein, as well as silicates (in particular zeolites), borates, and phosphates. Such substances for separators as well as methods for the manufacture of separators are disclosed in EP 1 783 852.

The ceramic material has a porosity, which is sufficient for the functioning of the electrochemical cell, however, compared to conventional separators, which do not comprise a ceramic material, is substantially more heat-resistant and has less shrinkage at higher temperatures. Furthermore, a ceramic separator preferably has a high mechanic stability.

In particular, together with the active material according to the invention for the cathodic electrode, which results in an increased thermal stability and aging resistance, the ceramic separator may be decreased in its layer thickness such that due to superior reliability and mechanical stability, the cell dimensions may be minimized and the energy density may be increased. This allows, among others, to achieve the intended low thicknesses of the carriers/electrodes according to the invention without negatively affecting the reliability of the cell.

In the electrochemical cell of the present invention, the following separator thicknesses are preferred: 2 μm to 50 μm, in particular from 5 μm to 25 μm, further preferred from 10 μm to 20 μm. The increased thermal stability and aging resistance of the cathodic electrode—as disclosed above—allows to form the separator layer, having an intrinsic resistivity, to have a lower thickness, and thus with a lower cell impedance compared to separators of the prior art.

It is further preferred that the inorganic substance, respectively the ceramic material, is present in form of particles having a largest diameter of less than 100 nm.

The inorganic substance, preferably the ceramic particles, is present/are present preferably on an organic carrier material.

Preferably, the separator is coated with a polyetherimide (PEI).

Preferably, as carrier material for the separator, an organic material is used, which preferably is formed as non-woven fabric, wherein the organic material preferably comprises a polyethylene glycol terephthalate (PET), a polyolefin (PO) or a polyetherimide (PEI), or mixtures thereof. The carrier material preferably is formed as foil or thin layer. In a particularly preferred embodiment, said organic material is or comprises a polyethyleneglycol terephthalate (PET).

In a preferred embodiment, this separator, which preferably is present as a composite of at least one organic carrier material with at least one inorganic (ceramic) substance, is formed as a layer composite in foil form, which, preferably, is coated on one side or on both sides with a polyetherimide.

In a preferred embodiment of a separator, the separator consists of a layer of magnesium oxide, which further preferably is coated on one or both sides with a polyetherimide.

In a further preferred embodiment, from 50 to 80 wt.-% of the magnesium oxide may be replaced by calcium oxide, barium oxide, barium carbonate, lithium phosphate, sodium phosphate, potassium phosphate, magnesium phosphate, calcium phosphate, barium phosphate or by lithium borate, sodium borate, potassium borate, or mixtures of these compounds.

The polyetherimide, with which in the preferred embodiment the inorganic substance is coated on one side or on both sides, is preferably present in form of the above-described (non-woven) fabric in the separator. The term “non-woven fabric” means that the fibers are present in non-woven form (non-woven fabric). Such fleeces are known from the prior art and/or may be produced according to the known methods, such as by means of a spun bonding or a melt-blown manufacturing process as referred to in DE 195 01 271 A1.

Polyetherimides are known polymers and/or may be produced according to known methods. For example, such methods are disclosed in EP 0 926 201. Polyetherimides are, for example, commercially available under the trademark Ultern®. Said polyetherimide may be present, according to the invention, in the separator or in a layer or in several layers, respectively on one side and/or on both sides of the layer of the inorganic material.

In a preferred embodiment, the polyetherimide comprises a further polymer. This at least one further polymer is preferably selected from the group consisting of polyester, polyolefin, polyacrylnitrile, polycarbonate, polysulfone, polyethersulfone, polyvinylidene fluoride, polystyrene.

Preferably, the further polymer is a polyolefin. Preferred polyolefins are polyethylene and polypropylene.

The polyetherimide, preferably in form of the non-woven fabric, is preferably coated with one or further layers of a further polymer, preferably of a polyolefin, which, preferably, is also present as non-woven fabric.

The coating of the polyetherimide with the further polymer, preferably the polyolefin, may be achieved by bonding, lamination, or by means of a chemical reaction, by means of welding or by means of a mechanical connection. Such polymer composites as well as methods for the manufacture thereof are known from EP 1 852 926.

Preferably, the fleeces are made from nanofibers or from technical glasses of the used polymers, wherein fleeces are formed, which have a high porosity while forming small pore diameters.

Preferably, the diameters of the fibers of the polyetherimide fleece are larger than the fiber diameter of the further polymer fleece, preferably of the polyolefin fleece.

Preferably, the non-woven fabric made from polyetherimide has a higher pore diameter than the non-woven fabric, which is made from the further polymer.

The use of a polyolefin additionally to the polyetherimide ensures an increased reliability of the electrochemical cell since with undesired or excessive heating of this cell the pores of the polyolefin contract and thus the charge transport through the separator is reduced, respectively shut down. If the temperature of the electrochemical cell should rise to a temperature at which the polyolefin starts melting, the polyetherimide, which is very stable against temperature influence, effectively counteracts the melting of the separator and thus uncontrolled damage of the electrochemical cell.

Preferably, the ceramic separator is formed from a flexible ceramic composite material. A composite material is made from different materials, which are rigidly connected to one another. Such a material may also be termed “composite material”. In particular, it is provided that this composite material is formed from ceramic materials and from polymeric materials. It is known to provide a fleece made from PET with a ceramic impregnation, respectively coating. Such composite materials can resist temperature above 200° C. (partially up to 700° C.).

Preferably, a separator layer, respectively a separator, extends at least partially across a boundary edge of at least one in particular adjacent electrode. Particularly preferred a separator layer, respectively a separator, extends across all boundary edges of in particular adjacent electrodes. Thus, also electrical currents between the edges of electrodes of an electrode stack are diminished, respectively prevented.

For the manufacture of the electrochemical cell according to invention, methods may be used, which, in principle, are known, such as the methods, which are described in “Handbook of Batteries”, Third Edition, McGraw-Hill, Editors: D. Linden, T. B. Reddy, 35.7.1.

In one embodiment, the separator layer is directly formed on the negative or the positive electrode or the negative and the positive electrode.

Preferably, the inorganic substance of the separator is directly applied as paste or dispersion to the negative electrode and/or the positive electrode. By means of co-extrusion, a laminated composite results. For the present invention, thereby a paste extrusion is particularly preferred.

The laminate composite then comprises an electrode and the separator, respectively both electrodes and the separator between the electrodes.

After the extrusion, the produced composite may be dried, respectively sintered according to the common methods, if necessary.

It is also possible to produce the anodic electrode and the cathodic electrode as well as the layer of the inorganic substance, thus the separator, separately from one another. The inorganic substance, respectively the ceramic material, then is present/are present preferably in the form of a foil. The electrodes and the separator, which are produced separately from one another, are then continuously and separately fed into a processing unit, wherein the combined negative electrode and the separator and the positive electrode are (preferably) laid to a cell composite, or are laminated, or are wound. Preferably, the processing unit comprises or consists of laminating rollers. Such a method is known from WO 01/82403.

### EXAMPLES

In the following, the manufacture of an electrochemical cell according to the Invention comprising both electrodes, in particular a cathodic electrode and a separator in an electrolyte having a casing is described.

According to the invention, due to the increased thermal stability and aging resistance of the cathodic electrode, a significantly lower separator thickness may be selected (compared to an exclusive use of lithium-nickel-manganese-cobalt mixed oxide for the cathodic electrode) and thus, all in all, a higher energy density and power density may be achieved.
a) From dimethyl formamide, polyetherimide fibers having an average fiber diameter of approximately 2 μm are electrostatically spun, and these are processed to a non-woven fabric, which has a thickness of approximately 15 μm.
b) 25 parts by weight of LiPF₆ and 20 parts y weight of ethylene carbonate, 10 parts by weight of propylene carbonate or EMC, 25 parts by weight of magnesium oxide and 5 g of Kynar 2801®, a binder, are mixed with one another and are dispersed in a disperser until a homogeneous dispersion is formed.
c) A dispersion produced in b) is applied onto the fleece produced in a) such that the applied layer has approximately a thickness of 20 μm (separator).
d) A mass of a mixture of 75 parts by weight of MCMB 25/28® (mesocarbon microbeads (Osaka Gas Chemicals)), 10 parts by weight of lithium oxalate borate, 8 parts by weight of Kynar 2801® and 7 parts by weight of propylene carbonate are applied onto an aluminum foil having a thickness of 18 μm by means of an extruder, wherein a thickness of the applied layer of approximately 20 to 40 μm results (anodic electrode).
e) A paste of a mixture of 50 parts by weight of lithium-nickel-manganese-cobalt mixed oxide (NMC) in layer structure, 30 parts by weight of lithium-manganese oxide (LMO) in a spinel structure, 10 parts by weight of Kynar 2801® and 10 parts by weight of propylene carbonate are applied onto an aluminum foil having a thickness of 18 μm (cathodic electrode).
f) The layers produced according to c), d), and e) are wound on a winding machine such that the product according to c) is between the coatings of the products according to d) and e), wherein the polyetherimide fleece contacts the coating of the product according to Example e). The metal foils (collector foils) are connected and are provided with conductors and the system is encased in a shrink film.

The anode in the scope of the present example preferably is a graphite system made from a “soft carbon” coated with a “hard carbon”, wherein the “hard carbon” is present only in an amount up to 15%.

The cathode is designed for large-sized stacked cells, i.e. in particular coated as pattern form or is in pattern form. The formed cells also exhibit in the “high energy” embodiment a high load durable up to 10C, they are resistant against aging and have excellent cycle properties of >5,000 full cycles (80%). Manipulated insertion of a copper fluff or of a copper chip were encased by the polymers, which were injected, and thus could not form a sectorial “hot spot”. The “high power” embodiment is extremely cycle-stable and loadable, beyond >20C.

With respect to the electrolyte, it could be shown that it is sufficient to use simple mixtures such as EC/EMC 1:3 with an additive such as VC or “redox shuttle” (without further additives, which are partially polluting or risky), since the effect of the additive is given via the microinjection into the electrode. Thereby, the electrolyte becomes more environment-friendly and cheaper and a very good result could be evidenced in over-compliance of the cold start current (“cold cranking test”).

1-14. (canceled)

15. An electrochemical cell, comprising:
a cathode electrode comprising at least one carrier having at least one active material applied or deposited thereon, wherein the active material comprises a mixture of:
(1) at least one lithium polyanion compound, and
(2) at least a mixture of a lithium-nickel-manganese-cobalt-mixed oxide (NMC), which is not present in a spinel structure, with a lithium-manganese oxide (LMO) in a spinel structure;
wherein the carrier comprises a metallic material, and the carrier has a thickness of 15 μm to 45 μm;
an anodic electrode, and
a separator, which at least partially is located on or between a cathodic electrode and/or an anodic electrode, wherein the separator comprises at least one porous ceramic material, which is present in a layer applied to an organic carrier material.

16. The electrochemical cell according to claim 15, wherein the metallic material is aluminum.

17. The electrochemical cell according to claim 15, wherein the carrier is formed as a collector foil.

18. The electrochemical cell according to claim 15, wherein the active material comprises at least 50% of at least one lithium polyanion compound.

19. The electrochemical cell according to claim 18, wherein the compound is selected from the group consisting of Na superion conductors, pyrophosphates, olivines, amorphous iron phosphates, MoXOH, brannerite, and borates

20. The electrochemical cell according to claim 18, wherein the at least one lithium polyanion compound is selected from the sub-group consisting of M³⁺(X⁶⁺O₄)₃, LiM³⁺₂(X⁶⁺O₄)₂(X⁵⁺O₄), LiM³⁺₂(X⁵⁺O₄)₃, LiM⁴⁺₂(X⁵⁺O₄)₃, Li₂M⁴⁺M³⁺(X⁵⁺O₄)₃, Li₂M⁵⁺M³⁺(X⁵⁺O₄)₃, M⁵⁺M⁴⁺(X⁵⁺O₄)₃, M⁵⁺OX⁵⁺O₄, LiM⁴⁺OX⁵⁺O₄, M⁴⁺OX⁶⁺O₄ and Li₂M⁴⁺OX⁴⁺O₄.

21. The electrochemical cell according to claim 15, wherein the active material comprises at least 30 mole % of lithium-nickel-manganese-cobalt mixed oxide, as well as simultaneously at least 10 mole % of lithium-manganese oxide, based on the total moles of the active material of the cathodic electrode, respectively.

22. The electrochemical cell according to claim 15, wherein combined NMC and LMO constitute at least 60 mole % of the active material, based on the total moles of the active material of the cathodic electrode, respectively.

23. The electrochemical cell according to claim 15, wherein the at least one active material applied or deposited on the carrier comprises said active material in an amount of from 80 to 90 weight-%, based on the total weight of the material as applied onto the carrier, respectively.

24. The electrochemical cell according to claim 15, wherein the cathode electrode comprises a stabilizer which is applied on the carrier.

25. The electrochemical cell according to claim 15, wherein the anode electrode comprises at least one carrier having a thickness of from 15 μm to 45 μm.

26. The electrochemical cell according to claim 15, wherein the organic carrier material comprises a non-woven fabric.

27. The electrochemical cell according to claim 15, wherein the separator is coated on one side or both sides with a polyetherimide.

28. The electrochemical cell according to claim 15, wherein the ceramic material is selected from the group consisting of oxides, phosphates, sulfates, titanates, silicates, aluminosilicates and borates of at least one metal ion.

29. The electrochemical cell according to claim 15, wherein the separator has a thickness of from 2 to 50 μm.

30. A method comprising:
powering an electrical tool via the electrochemical cell according to claim 15.

31. A method comprising:
powering a vehicle via the electrochemical cell according to claim 15.

32. The method according to claim 31, wherein the vehicle is (a) at least predominately electrically driven or (b) driven by a hybrid drive comprising electrical driving from the at least one electrochemical cell combined with a combustion engine or a fuel cell.
